(19) United States
(12) Patent Application Publication
(10) Pub. No.: US 2003/0093581 A1
(43) Pub. Date: May 15, 2003

(54) Telecommunications system architecture

(75) Inventors: Jeffrey Oliver, Tustin, CA (US); Raymond Diaz, Irving, CA (US)

Correspondence Address: Fogg, Slifer & Ploglaze, P.A., P.O. Box 581009, Minneapolis, MN, 55458-1009, US

(73) Assignee: ADC DSL Systems, Inc.

(21) Appl. No.: 10/008,649

(22) Filed: Nov. 9, 2001

(51) Int. Cl. G06F 13/10; G06F 9/00; G06F 9/54; G06F 15/163

(52) U.S. Cl. 709/321

(57) ABSTRACT

A modular telecommunications system architecture creates individual system function modules, and allows a modular architecture supporting a wide array of configurations for the telecommunications system. Each module is operated through an application interface between a driver set and the module, and the application interface is defined so as to accommodate a number of different drivers for each of the modules. This modular architecture allows easy swapping of modules, and modification of modules, without requiring reprogramming of the application interfaces.

The present invention relates generally to telecommunications, and more specifically to an architecture for a telecommunications system.

### BACKGROUND

As the telecommunications field continues to grow, new technologies are in constant development. As those new technologies develop, and as existing technologies are modified, the systems that run the technologies, both existing and new, must be modified to accommodate the changes and developments. There are a number of problems with modification of existing systems to accommodate new and changing technology. One such problem is that arises when new or changed technologies must be implemented into existing systems is that the systems are not designed to accommodate the changes. That is, existing systems are designed in such a way that the architecture is integrated among various modules and subsystems within the system as a whole.

Functions of a typical telecommunications system are spread out among a number of different locations within a typical telecommunications system. A single change to one function in a telecommunications system may presently require extensive modifications to numerous sections of the system, including the base code that operates the system, the actual function code, and any function code that uses the sub-system or function that is to be changed.

Addition of new modules or functions to a telecommunications system similarly takes a great deal of code modification, as every sub-system that cooperates with or uses a particular function may need to be recoded or have its code modified to allow it to operate with the new module or function.

As improvements continue to occur, and as changes to systems become increasingly more difficult to accomplish, entire systems are many times required to be replaced due to obsolescence. There is therefore a need in the art for a telecommunications architecture that allows for implementation of changes to a system without the need for large amounts or modification to the base system.

### SUMMARY

In one embodiment, an architecture for a telecommunications device includes a number of operational modules, and a corresponding number of application interfaces (API). Each API provides functionality for one of the operational modules, and each API is broadly defined to allow operation of multiple driver sets depending upon a desired driver for the system.

In another embodiment, an architecture for a telecommunications transport device includes an application layer, a framework layer, and a hardware driver layer. A number if interfaces between each layer and each other layer provide interaction between the layers.

In yet another embodiment, a modular architecture for a telecommunications system includes a number of function modules, each function module supported by a driver set, and a number of application interfaces, each application interface broadly defined to support the driver set for its respective function module.

In still another embodiment, a method for defining a telecommunications system architecture includes defining a number of driver sets, a driver set for each of a corresponding number of functions of the system, each of the driver sets supporting at least one driver for a respective function module, selecting a subset of system functions for inclusion in the system architecture, and applying one of the drivers of each driver set to its function module through an application interface layer between the driver and the function module.

In yet another embodiment, a method of making configuration changes in a telecommunications system includes defining a number of application interfaces, with each application interface facilitating communication between a driver set and a function module of the system. Each of the application interfaces supports a broadly defined set of operations within a predefined category of operations for a function module. A driver from the driver set for each of the function modules is selected and applied to its respective function module through its respective application interface.

In still another embodiment, a method of operating telecommunications system includes defining a number of application interfaces, each application interface providing an interface between a driver module and the system, and applying one of a set of drivers to each of the application interfaces depending upon a predetermined driver need.

In still yet another embodiment, a method of communicating between individual modules in a telecommunications system includes defining a driver layer containing drivers for a number of system modules, with each of the system modules performing a specific system operation, and defining an application interface for each of the modules. The application interface is situated between one of the drivers in the driver layer of the system and one of the system modules, and each application interface is defined to support a known set of system functions.

Other embodiments are described and claimed.

### BRIEF DESCRIPTION OF THE DRAWINGS

FIG. 1 is a block diagram of a system architecture according to one embodiment of the present invention;

FIG. 2 is a block diagram of a driver structure and hardware component structure for a telecommunications system according to another embodiment of the present invention;

FIG. 3 is a block diagram of a system interface according to one embodiment of the present invention;

FIG. 4 is a block diagram of a line card on which embodiments of the present invention are employed; and

FIG. 5 is a block diagram of a computer on which embodiments of the present invention are employed.

### DETAILED DESCRIPTION

In the following detailed description of the embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The modules and systems of the various embodiments of the present invention are modular in design and in application. The modules are capable of being changed, withdrawn, added, or otherwise modified in a system. This approach provides increased flexibility in the design of architectures for telecommunications devices and systems. The basic functions of operations within the various modules and systems embodied herein remain largely the same over multiple telecommunications systems, and therefore lend themselves to the modular approach taken in the various embodiments.

The modular architecture of the present embodiments allows underlying firmware of the system to change. However, operation of the system remains the same regardless of changes to the firmware or drivers of the system. In this way, a system architecture for a telecommunications transport product is made modular, and can be employed in many different products. There are numerous similarities between multiple telecommunication transport products. The only major differences between various telecommunication transport products is the specific technologies that they employ. The functionality of most of the systems is common, that is all of the products all have the same basic functional blocks, such as a user interface, a backplane interface, some sort of data transport, and the like.

In functional partitioning as is described in further detail below, every piece of a system is modular, including for example, hardware, drivers, and applications. In one embodiment of the present invention, one twisted pair of copper wire is used for a digital subscriber line (DSL). Firmware and the architectures described below can accommodate many pairs, in fact as many as the memory of the system can handle. Therefore, the system is expandable. In one embodiment, various aspects of the system are split out from each other. User interfaces and management interfaces and the hardware interfaces are broken into small modular pieces that are replaced or expanded upon as necessary when changes are made to the system. Such changes include additions, modifications, and deletions, by way of example.

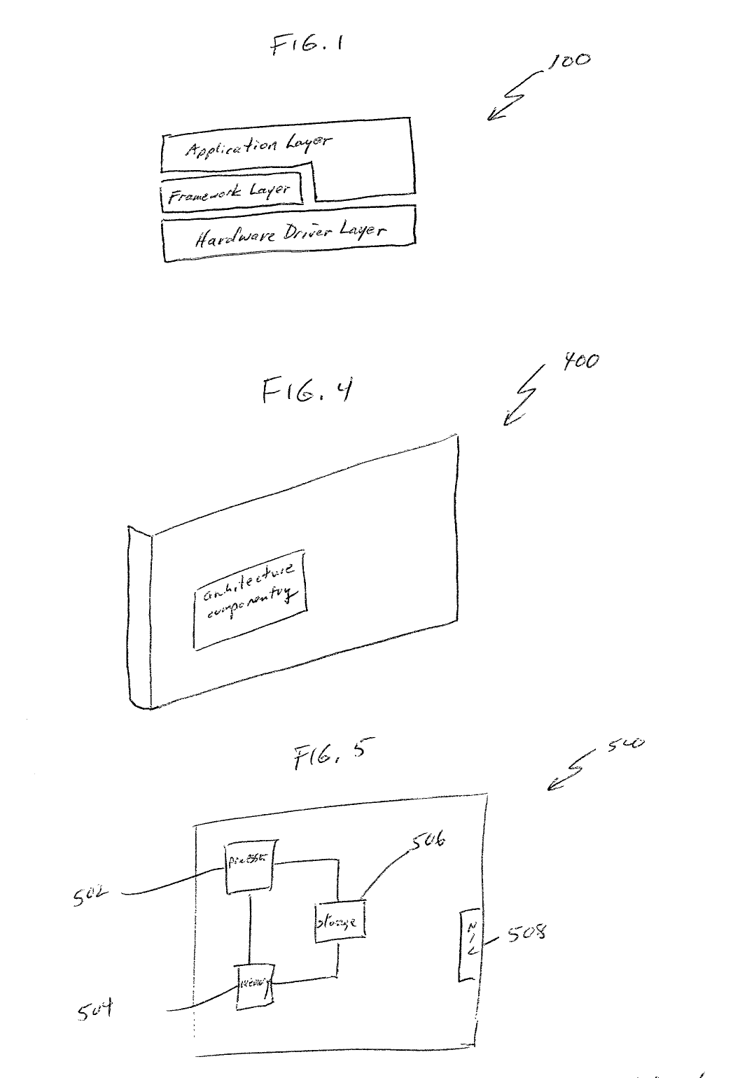

In one embodiment shown in FIG. 1, a system architecture 100 for a telecommunications system is shown. System architecture 100 comprises in one embodiment an application layer 102, a framework layer 104, and a hardware layer 106. The layers 102, 104, and 106 are independent of each other, and have interfaces therebetween provided any necessary interaction between the layers.

The application layer 102 provides the system functionality. Functions of the application layer include user interfaces, performance monitoring, and transport control. Each layer is independent from the other layers, with well defined interfaces providing any needed interaction between layers. The application layer contains what the outside world sees of the system. The user, that is the operator of the unit, interfaces with an application layer component, for example another unit in the circuit might interface with the application layer.

In one embodiment, a line card and a system as a whole are broken into smaller pieces, in this embodiment the application layer 102, framework layer 104, and hardware driver layer 106. In this embodiment, the various pieces of the software for user operation of the system are broken down into individual components, the separate pieces of the software for hardware operation of the system are also broken down into individual pieces, and the separate pieces of software for operation of the entire architecture that the system is based upon, namely the framework, including for example the operating system and the system services, are also broken down into individual pieces. Each of the pieces is then available for use in its respective layer, and an entire modular architecture employing only those desired or required components is assembled from the pieces.

Functional partitioning is present in the application layer. Functional partitioning is in one embodiment the isolation of separate functions from all aspects of operation of a telecommunications device. In this isolation, each function of an operation of the system is broken out into its own module. In some embodiments, related functions are gathered together in a single module. Therefore, for each operation, a single module performs the operation. In such a system, individual modules are gathered together in the specific architecture desired. In other words, a telecommunications system is structured in such a way that any operation can be added without affecting the other operations present in the system.

To allow control of the various operations and functions of a typical telecommunications system, application programming interfaces (APIs) are drafted. The APIs are written in one embodiment so as to allow functionality for operations and functions that are standard to the type of module, but which are not necessarily always used in the module. For example, if standards change, or updates are made, the drivers for the module can be modified, but the API for each module remains the same. It is the APIs that interact in the system for smooth operation of the architecture, and they are seamless to the actual drivers used. That is, the drivers can change, but the underlying architecture of the product remains the same.

Every function or operation of the system operates separately but is tied together with the APIs for the various functions or operations. Any module that interacts with any other module on the system has its own API. That structure provides modularity and an ability to quickly change code without affecting other modules. As long as the operation of the API is known, the drivers underlying the API are changeable in a manner that is seamless to a user. For example, if a new feature is added, change the driver for the specific module changes, but the API remains the same so that to the rest of the system it appears as if the module has not changed. The APIs are designed with a wealth of features to ensure that each API can accommodate new modules or new features in the modules without serious modification to the API. This is possible due to the known nature of telecommunication transport functions and operations.

The framework layer 104 provides the basic process control structures, such as active components, and common libraries in the system 100. Active components include, by way of example only and not by way of limitation, tasks, events, synchronization semaphores, inter-process communication queues, and the like. The real time operating system (RTOS) of the communications system is also part of the framework layer 104. Also included in the framework layer 104 are common library routines, which include any generic operation that is shared within the application layer. The framework layer 104 provides the driver layer 106 and the application layer 102 with process control structures, such as active components, and common libraries. Common libraries of the framework layer 104 include utility functions that are used throughout the system 100. The use of common libraries promotes code reuse.

The hardware driver layer 106 contains the device drivers of the system 100. The hardware driver layer 106 contains detailed knowledge of the underlying hardware components of the system 100. Hardware driver layer 106 is directly affected by changes in the hardware of the system 100. The hardware driver layer 106 primarily provides the framework layer 104 and application layer 102 independence from the underlying hardware configuration. The driver layer 106 is comprised in one embodiment of device drivers, each device driver providing hardware specific services to higher layers through a defined interface. The back end of the drivers, the hardware interface, is performed through either memory mapped input/output (I/O) or through I/O port pins. Drivers in some embodiments contain active components such as tasks, event handlers, ISRs, and the like that are responsible for maintenance of their particular hardware component.

In developing APIs for the various embodiments of the present invention, a process of identifying the technologies and the variations on those technologies is undertaken. The technologies have two distinct parts, namely common parts and specific or non-common parts. Common parts are those portions of the technology that are universal to the function, module or operation for which the API is being developed. The common parts are present in all or substantially all of the various different configurations of a module, function, or operation. Non-common parts are specific to the technology.

For example, an API for E1, T1, and J1 chipset drivers would have common parts that are universal to chipset drivers for those types of chipsets. The non-common parts are those specific parameters and the like that are unique to the individual chipsets. In one embodiment, the x1 chipset is placed in a system using an E1 transport card. However, in the future, such a system may employ a T1 or a J1 transport card. The API driver for the x1 chipset driver contains the specific non-common information that allow its support of both T1 and J1 line cards if the user changes the transport card to one of those types of cards. The API is written to allow it to function with not only an E1 card, but also with T1 and J1 cards as well.

When the line card is changed, for example from an E1 card to a T1 card, the API itself stays the same, and therefore the user does not see any manifest changes. The chipset driver changes but looks seamless to the rest of the firmware.

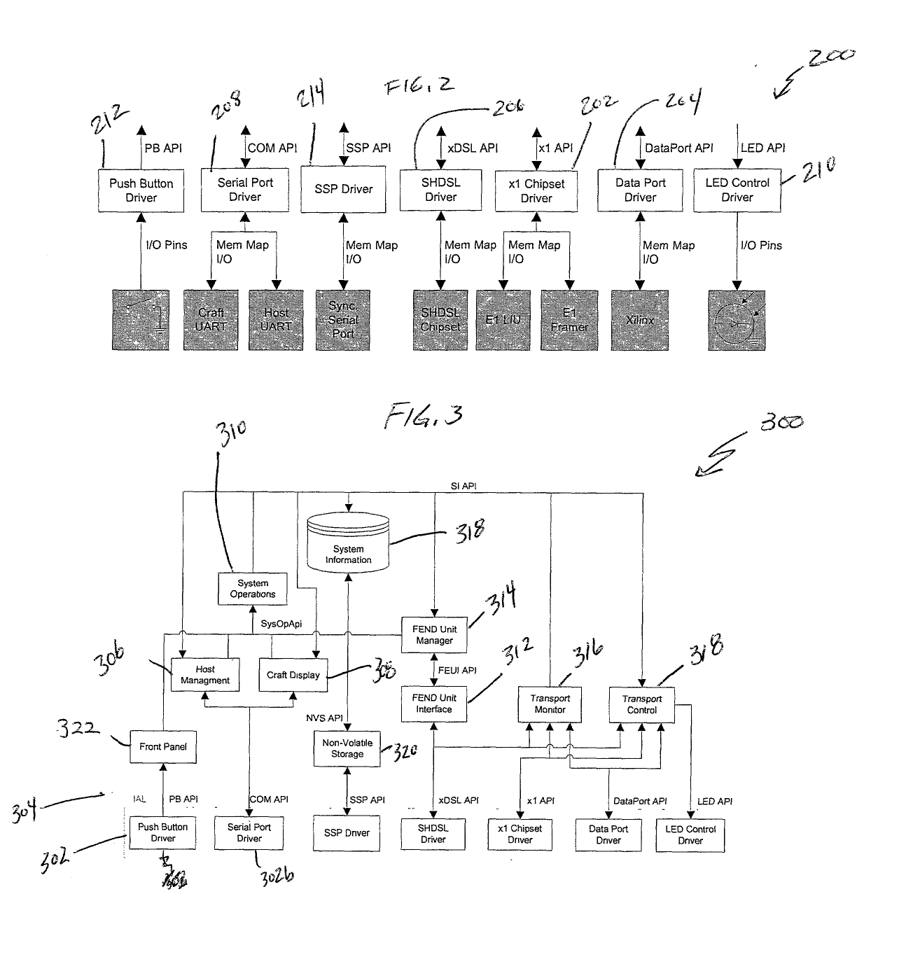

It should be understood that the specifics of writing APIs encompassing the various technologies are within the scope of one of skill in the field, and are within the scope of the invention. Each of the other modules or drivers, such as those shown in FIG. 3, has a similar architecture with its own specific API. Each API is the common entry point for every other piece. The underlying firmware such as the driver may change but to the system, the change is seamless.

FIG. 2 shows one embodiment 200 of a driver structure and hardware components for a telecommunications system such as system 100. In this embodiment, the x1 chipset driver 202 provides T1/E1/J1 port configuration and device monitoring, the data port driver 204 provides V.35/V.36/RS530/X.21 port configuration and device monitoring, the xDSL port driver 206 provides SHDSL port configuration and device monitoring, the serial port driver 208 provides asynchronous serial port configuration, performs an auto-baud algorithm, and transmits and receives serial data. The LED driver 210 provides LED configuration and control. The push-button driver 212 monitors the state of the push-button. The synchronous serial port (SSP) driver 214 provides and manages device connections via SSP, configures the SSP connection, and provides buffer transmission and data reception. An embodiment of the associated hardware for each of the drivers is shown in the figure as well. It should be understood that other drivers may be present in other systems, and that the modularity of the drivers and the associated APIs for the drivers allows a system architecture created with the modular components to be flexible so as to provide the exact system desired by the user, with the extra capability for addition and reconfiguration without the need to entirely redesign the architecture.

One embodiment of a system interface 300 for the architecture is shown in FIG. 3. Each component in the layers such as layers 102, 104, and 106 described above use defined interfaces as a way of accessing services and information from other components in the system. This helps promote portability and manageability. FIG. 3 shows the interfaces used between the application layer modules and the hardware drivers. Each of the drivers shown in FIG. 3 are for certain components or common functions of a telecommunications system such as system 100. The drivers control the operation of the functions or components. They provide the instructions for operation, and verify just what it is that the drivers do.

Each driver uses an API for managing the functions controlled by the drivers. The APIs are designed, as has been described above, to accommodate a wide range of various functions which is typically more broad than any single actual drivers used with the system. This allows the drivers to be changed, while the APIs remain the same. The change of a driver does not therefore require the changing of an API. The APIs remain the same, and if a driver changes, the change of that driver is seamless to the actual system, since the API doesn't change. In some embodiments, minor changes are effected to APIs. However, in most instances, the API does not change when a driver changes.

The system interface 300 comprises in one embodiment a plurality of drivers 302 which are interfaced with the system via a plurality of matching APIs 304. Various modules and controls are also present in this embodiment, including host management module 306, craft display 308, systems operation module 310, far end (FEND) unit interface 312, FEND unit manager 314, transport monitor 316 and transport control 316. A system information database 318 stores and maintains information pertaining to the configuration of the system, and also writes the information to non-volatile storage 320.

Referring again to FIG. 3, an example of an operation on the system is shown. In operation, the x1 API is programmed so as to allow the use of not only a T1 chipset driver, but also an E1 chipset driver, and the like. It is likely that only one type of chipset driver will be used at any given time, but it is foreseeable that the driver may change as the functions and operation of the system may change over time, that is, the drivers will be modified to allow the system to accommodate a different set of drivers. Since the API is programmed to allow the changes, the API does not require modification when a driver changes. The modularity of such a system provides advantages over previous configurations in that if the drivers change, the system does not require wholesale programming changes. Instead, the system accommodates the changes without requiring the system programming to be modified.

By way of example, a simple configuration change operates as follows in one embodiment, with reference to FIG. 3. In this example, a user desires to change the configuration of the bandwidth allocated to the E1 interface. In this embodiment, the user operates a terminal program of some sort to connect to the craft interface of the line unit. The terminal program can be any terminal program allowing a connection to the craft interface.

To configure the bandwidth allocated to the E1 interface, the following process is used. The user enters keystrokes identifying the desired bandwidth change into the unit 300 via the terminal program. The keystrokes are collected by the Serial Port Driver 302b. The keystrokes are then passed to the Craft Display 308, which in one embodiment is a user interface screen generator. The Craft Display 308 processes each keypress and determines that the user desires to change the E1 bandwidth. The Craft Display 308 passes the new E1 bandwidth information to the System Operations module 310, at which point the information is validated, the rest of the validation system is updated, and the new information is set into the System Information Database 318. Further details of the systems operation module 310 is contained in U.S. Patent Application entitled SYSTEMS OPERATION MODULE, which is owned by the assignee of the present invention, and which is herein incorporated by reference in its entirety.

The System Information database 318 stores the new information into a correct place in the database 318. It also sends a signal to Non-Volatile Storage 320 to write this new information into storage 320. Storage 320 can be any of a number of non-volatile storage media, including by way of example only and not by way of limitation, random access memory (RAM) such as dynamic RAM, static RAM, synchronous DRAM, optical storage, flash memory, magnetic media, EEPROM, and the like. The System Information database 318 also sends a signal to the Transport Control module 318. The Transport Control module 318 updates the hardware via the APIs 304 and their associated drivers 302 to carry out the configuration change. In this embodiment, the G.SHDSL hardware and the E1 hardware are affected. Finally, the System Information database 318 sends a signal to the Far End Unit Manager 314, which contains an Embedded Operations Channel (EOC). The EOC sends a message containing the new configuration change to a far end unit to synchronize the two ends' System Information databases.

Many configuration changes within a system such as system 300 are made in a similar fashion. Configuration changes may originate in various embodiments from the Craft Display 308, Host Management 306, Front Panel 322, or from the EOC within the FEND unit manager 314. All configuration changes are eventually stored in the database 318, and in some embodiments are also stored in the Transport Control 318 as well.

The various systems and methods described herein are in various embodiments implemented in a line card, a telecommunications system, and the like. FIG. 4 is a block diagram of a line card 400 on which embodiments of the present invention are employed. Architecture components 402 such as those described above are implemented on the line card 400. Such a line card 400 is insertable into a telecommunications system such as a chassis rack or the like.

The methods described herein may be implemented in whole or in part in various embodiments in a machine readable medium comprising machine readable instructions for causing a computer such as is shown in FIG. 5 to perform the methods. The computer programs run on a central processing unit 502 out of main memory 504, and may be transferred to main memory from permanent storage 506 via disk drive or CD-ROM drive when stored on removable media or via a network connection 508 or modem connection when stored outside of the computer 500, or via other types of computer or machine readable media from which it can be read and utilized.

Such machine readable media may include software modules and computer programs. The computer programs may comprise multiple modules or objects to perform the methods or the functions of various apparatuses described herein. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### Conclusion

The various embodiments of the present invention have a number of advantages over previous systems and apparatus. The modular nature of the architectures described herein provide for easy swapping of modules, drivers, and the like without affecting a major change to the system architecture. The modular components are reusable for different architectures for telecommunications transport architectures and systems. Another telecommunications product can be built using the modular blocks and methods of the present invention. The common features of telecommunications architectures and telecommunications system functions allow this modularity.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. An architecture for a telecommunications device, comprising:
a plurality of operational modules; and
a plurality of application interfaces (API), each API providing functionality for one of the plurality of operational modules, wherein each API is broadly defined to allow operation of multiple driver sets depending upon a desired driver for the system.

2. The architecture of claim 1, wherein at least one of the plurality of interfaces supports a plurality of different drivers, and wherein the at least one of the plurality of interfaces comprises:
a first portion of information common to each of the plurality of different drivers; and
a second portion of information specific to one of the plurality of different drivers.

3. An architecture for a telecommunications transport device, comprising:
an application layer;
a framework layer;
a hardware driver layer; and
a plurality of interfaces, an interface between each layer and each other layer, the plurality of interfaces providing interaction between the layers.

4. The architecture of claim 3, wherein each of the plurality of interfaces supports a broadly defined set of operations within a predefined category of operations.

5. The architecture of claim 3, wherein at least one of the plurality of interfaces supports a plurality of different drivers, and wherein the at least one of the plurality of interfaces comprises:
a first portion of information common to each of the plurality of different drivers; and
a second portion of information specific to one of the plurality of different drivers.

6. An architecture for a telecommunications device, comprising:
an application layer;
a framework layer; and
a hardware layer, the layers connected through a plurality of interfaces between each layer and each other layer, wherein the architecture further comprises:
a plurality of modules, each module capable of performing a function of the system.

7. A modular architecture for a telecommunications system, comprising:
a plurality of function modules, each function module supported by a driver set; and
a plurality of application interfaces, each application interface broadly defined to support the driver set for its respective function module.

8. A method for defining a telecommunications system architecture, comprising:
defining a plurality of driver sets, a driver set for each of a plurality of functions of the system, each of the plurality of driver sets supporting at least one driver for a respective function module;
selecting a subset of the plurality of system functions; and
applying one of the at least one driver of each driver set to its respective function module through an application interface layer between the driver and the function module.

9. The method of claim 8, and further comprising:
changing the driver applied to a function module without changing the application interface.

10. A method of making configuration changes in a telecommunications system, comprising:
defining a plurality of application interfaces, each application interface facilitating communication between a driver set and a function module of the system, wherein each of the application interfaces supports a broadly defined set of operations within a predefined category of operations for a function module;
selecting a driver from the driver set for each of the function modules; and
applying the selected driver to its respective function module through its respective application interface.

11. A method of operating telecommunications system, comprising:
defining a plurality of application interfaces, each application interface providing an interface between a driver module and the system; and
applying one of a set of drivers to each of the plurality of application interfaces depending upon a predetermined driver need.

12. The method of operating a telecommunications system of claim 11, wherein applying one of a set of drivers is seamless to a user of the system.

13. The method of operating a telecommunications system of claim 11, wherein defining further comprises:
generating a set of common instructions for each of the drivers in the set of drivers, the common instructions applicable to each of the drivers of the set of drivers; and
generating a plurality of sets of non-common instructions, a set of non-common instructions for each of the drivers in the set of drivers.

14. A machine readable medium having machine readable instructions for causing a computer to perform a method comprising:
defining a plurality of application interfaces, each application interface providing an interface between a driver module and the system; and
applying one of a set of drivers to each of the plurality of application interfaces depending upon a predetermined driver need.

15. The machine readable medium of claim 14, wherein applying one of a set of drivers is seamless to a user of the system.

16. A method of communicating between a plurality of individual modules in a telecommunications system, comprising:
defining a driver layer containing a plurality of drivers for a plurality of system modules, wherein each of the system modules performs a specific system operation;
defining a plurality of application interfaces, an application interface between one of the plurality of drivers in the driver layer of the system and one of the system modules, each application interface defined to support a predetermined set of system functions.
